(19) United States
(12) Patent Application Publication
(10) Pub. No.: US 2010/0061347 A1
(43) Pub. Date: Mar. 11, 2010

(54) SYNCHRONIZATION MECHANISM FOR ALLOWING COEXISTENCE OF NODES IN THE SAME FREQUENCY BAND

(75) Inventor: Vered Bar Bracha, Hod Hasharon (IL)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/266,042

(22) Filed: Nov. 6, 2008

Related U.S. Application Data
(60) Provisional application No. 61/095,239, filed on Sep. 8, 2008.
(60) Provisional application No. 61/096,243, filed on Sep. 11, 2008.

(51) Int. Cl. H04W 72/04

(52) U.S. Cl. 370/336

(57) ABSTRACT

Certain aspects provide a technique for managing transmissions in a wireless network. The technique generally provides for an access terminal to transmit synchronization packets containing timing information regarding an existing piconet. The synchronization packets may contain an indication of resources of the piconet allocated to the access terminal by an access point.

### CLAIM OF PRIORITY UNDER 35 U.S.C. §119

The present Application for Patent claims priority to Provisional Application No. 61/095,239 entitled “SYNCHRONIZATION MECHANISM FOR ALLOWING COEXISTENCE OF NODES IN THE SAME FREQUENCY BAND” filed Sep. 8, 2008, and Provisional Application No. 61/096,243 entitled “SYNCHRONIZATION MECHANISM FOR ALLOWING COEXISTENCE OF NODES IN THE SAME FREQUENCY BAND” filed Sep. 11, 2008, and assigned to the assignee hereof and hereby expressly incorporated by reference herein.

### BACKGROUND

1. Field

The invention relates generally to wireless communication and, more particularly, to wireless personal area networks commonly referred to as piconets.

2. Background

A “piconet” is generally defined as a wireless personal area network that is composed of a group of wireless devices such as an “access terminal,” an “access point” or both such devices in close proximity to one another. A piconet is typically controlled by an access point that assumes the role of a Piconet Coordinator (PNC) that acts as a master terminal that schedules access to the communications medium for the other access terminals in its piconet. Frames are the basic unit of data transport in a piconet, which can include data, acknowledgment, beacon and MAC command frames.

A PNC may also define a superframe structure consisting of multiple frames, with beacons acting as boundaries and providing synchronization to other devices. The IEEE 802.15.3 standard specifies that the PNC sends a beacon to synchronize data exchanges between the PNC and the terminals in the piconet. The beacon signals a start of a superframe and allows each terminal to reset its superframe clock to zero at the beginning of a beacon preamble.

Certain drafts of the IEEE 802.15.3 standard mandate that all PNC capable devices, when operating as PNC, shall transmit common rate beacon in every superframe and that all PNC capable devices shall be able to receive the common rate beacon and command frames. This mechanism is designed to allow PNC capable devices to become aware of existing piconets, which will allow them to join and, more importantly, prevent them from forming independent piconets that may cause interference to devices that are in range of both piconets.

Unfortunately, a PNC capable device within range of some devices of an existing piconet may not be in range of the piconet's PNC. As a result, such a device (which may be referred to as a “hidden node”) may not detect the beacon preventing it from joining the existing piconet. Even more problematic, the hidden node may form an independent piconet and cause interference to devices that are in range of both piconets.

### SUMMARY

Certain aspects provide a method of communication. The method generally includes receiving, from a node in a piconet, an allocation of resources for data transmissions in the piconet and transmitting a synchronization packet containing information regarding the allocation of resources.

Certain aspects provide a method of communication. The method generally includes receiving, from a node in an existing piconet that is not acting as a piconet coordinator, a synchronization packet containing information regarding the allocation of resources in the piconet and scheduling data transfers, based on the information contained in the synchronization packet, to avoid interference with data transfers in the existing piconet.

Certain aspects provide an apparatus of communication. The apparatus generally includes logic for receiving, from a node in a piconet, an allocation of resources for data transmissions in the piconet and logic for transmitting a synchronization packet containing information regarding the allocation of resources.

Certain aspects provide an apparatus of communication. The apparatus generally includes logic for receiving, from a node in an existing piconet that is not acting as a piconet coordinator, a synchronization packet containing information regarding the allocation of resources in the piconet and logic for scheduling data transfers, based on the information contained in the synchronization packet, to avoid interference with data transfers in the existing piconet.

Certain aspects provide an apparatus of communication. The apparatus generally includes means for receiving, from a node in a piconet, an allocation of resources for data transmissions in the piconet and means for transmitting a synchronization packet containing information regarding the allocation of resources.

Certain aspects provide an apparatus of communication. The apparatus generally includes means for receiving, from a node in an existing piconet that is not acting as a piconet coordinator, a synchronization packet containing information regarding the allocation of resources in the piconet and means for scheduling data transfers, based on the information contained in the synchronization packet, to avoid interference with data transfers in the existing piconet.

Certain aspects provide a computer-program product for communication, comprising a computer readable medium having instructions stored thereon, the instructions being executable by one or more processors. The instructions generally include instructions for receiving, from a node in a piconet, an allocation of resources for data transmissions in the piconet and instructions for transmitting a synchronization packet containing information regarding the allocation of resources.

Certain aspects provide a computer-program product for communication, comprising a computer readable medium having instructions stored thereon, the instructions being executable by one or more processors. The instructions generally include instructions for receiving, from a node in an existing piconet that is not acting as a piconet coordinator, a synchronization packet containing information regarding the allocation of resources in the piconet and instructions for scheduling data transfers, based on the information contained in the synchronization packet, to avoid interference with data transfers in the existing piconet.

Certain aspects provide a method of communication. The method generally includes transmitting, by a node in a piconet, information indicating the node is capable of transmitting synchronization packets containing information regarding the allocation of resources in the piconet.

Certain aspects provide a method of communication. The method generally includes receiving, from a node in an existing piconet that is not acting as a piconet coordinator, an indication that the node is capable of transmitting synchronization packets containing information regarding the allocation of resources in the piconet and transmitting, to the node, one or more parameters indicating how the node should transmit the synchronization packets.

### BRIEF DESCRIPTION OF THE DRAWINGS

FIG. 1 illustrates an example piconet, in accordance with certain aspects of the present disclosure.

FIG. 2 illustrates example components of a piconet terminal, in accordance with certain aspects of the present disclosure.

FIG. 3 illustrates an example piconet with nearby terminals that are not included in the piconet.

FIG. 4 is a conceptual diagram illustrating an example of interference between terminals in a piconet and nearby terminals that are not included in the piconet.

FIG. 5 illustrates example operations for transmitting a unified synchronization packet, in accordance with certain aspects of the present disclosure.

FIG. 5A illustrates example components capable of performing the operations shown in FIG. 5.

FIG. 6 illustrates example operations for processing a detected unified synchronization packet, in accordance with certain aspects of the present disclosure.

FIG. 6A illustrates example components capable of performing the operations shown in FIG. 6.

FIG. 7 illustrates an example of a piconet that is virtually dependent on another piconet, in accordance with certain aspects of the present disclosure.

FIG. 8 illustrates an example synchronization frame format, in accordance with certain aspects of the present disclosure.

FIG. 9 illustrates an example synchronization frame body format, in accordance with certain aspects of the present disclosure.

FIG. 10 illustrates an example synchronization parameters field format, in accordance with certain aspects of the present disclosure.

FIG. 11 illustrates example operations for scheduling synchronization frame transmissions, in accordance with certain aspects of the present disclosure.

FIG. 11A illustrates example components capable of performing the operations shown in FIG. 11.

FIG. 12 illustrates an example exchange of synchronization frames, in accordance with certain aspects of the present disclosure.

FIG. 13 illustrates another example exchange of synchronization frames, in accordance with certain aspects of the present disclosure.

### DETAILED DESCRIPTION

Various aspects of certain aspects of the present disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

In the following detailed description, various aspects of the invention may be described in the context of a wireless network or “piconet” in accordance the IEEE 802.15 family of standards (whether adopted or proposed). While these inventive aspects may be well suited for use with such networks in which an access point (AP) may serve as a piconet coordinator (PNC), those skilled in the art will readily appreciate that these inventive aspects are likewise applicable for use in various other communication environments utilizing any type of access points (APs) and access terminals (ATs), including, but not limited to, networks in accordance with IEEE 802.11 family of standards and may, in fact, allow networks in accordance with different standards to better co-exist. Accordingly, any reference to an IEEE 802.15 compliant network is intended only to illustrate the inventive aspects, with the understanding that such inventive aspects have a wide range of applications.

The teachings herein may be incorporated into (e.g., implemented within or performed by) a variety of wired or wireless apparatuses (e.g., nodes). In some aspects, a node implemented in accordance with the teachings herein may comprise an access point or an access terminal.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium.

In some aspects, the node is a wireless node. Such wireless nodes may provide, for example, connectivity for or to a network (e.g., a personal area network or piconet, wide area network such as the Internet, or a cellular network) via a wired or wireless communication link.

### An Example Piconet

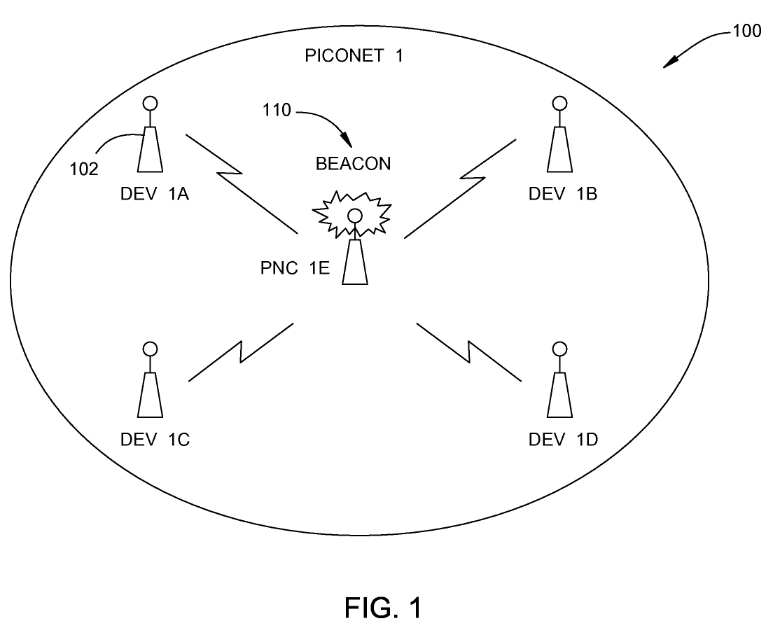

FIG. 1 illustrates an example piconet, Piconet 1. As shown, Piconet 1 may include a number of wireless devices 102 or “terminals” 1A-1E that can communicate with one another using relatively short-range wireless links 104. In the illustrated example, terminal 1E acts as a PNC for Piconet 1. Although illustrated with five devices, it should be appreciated that any number of devices (i.e., two or more) may form a wireless personal area network.

Each of the terminals 102 in the Piconet 1 may include, among other things, a wireless transceiver to support wireless communication and controller functionality to manage communication with the network. The controller functionality may be implemented within one or more digital processing devices. The wireless transceiver may be coupled to one or more antennas to facilitate the transmission of signals into and the reception of signals from a wireless channel. Any type of antennas may be used including, for example, dipoles, patches, helical antennas, antenna arrays, and/or others.

The devices in the Piconet 1 may include any of a wide variety of different device types including, for example, laptop, desktop, palmtop, or tablet computers having wireless networking functionality, computer peripherals having wireless networking capability, personal digital assistants (PDAs) having wireless networking capability, cellular telephones and other handheld wireless communicators, pagers, wireless network interface modules (e.g., wireless network interface cards, etc.) incorporated into larger systems, multimedia devices having wireless networking capability, audio/visual devices having wireless networking capability, home appliances having wireless networking capability, jewelry or other wearable items having wireless networking capability, wireless universal serial bus (USB) devices, wireless digital imaging devices (e.g., digital cameras, camcorders, etc.), wireless printers, wireless home entertainment systems (e.g., DVD/CD players, televisions, MP3 players, audio devices, etc.), and/or others. In one configuration, for example, a wireless personal area network may include a user's laptop computer that is wirelessly communicating with the user's personal digital assistant (PDA) and the user's printer in a short-range network. In another possible configuration, a wireless personal area network may be formed between various audio/visual devices in, for example, a user's living room. In yet another configuration, a user's laptop computer may communicate with terminals associated with other users in a vicinity of the user. Many other scenarios are also possible.

Standards have been developed, and are currently in development, to provide a framework to support development of interoperable products that are capable of operating as part of a wireless personal area network (e.g., the Bluetooth standard (Specification of the Bluetooth System, Version 1.2, Bluetooth SIG, Inc., November 2003), the IEEE 802.15 standards, etc.). The IEEE 802.15.3 standard, for example, is a high data rate wireless personal area network standard. In accordance with the IEEE 802.15.3 standard, one of the terminals within a piconet is selected as a Piconet Coordinator (PNC) to coordinate the operation of the network. For example, with reference to FIG. 1, the device PNC 1E represents a PNC for the Piconet 1 in an IEEE 802.15.3 implementation.

As shown, PNC 1E may transmit a beacon signal 110 (or simply “beacon”) to other devices of Piconet 1, which may help the other terminals within Piconet 1 synchronize their timing with PNC 1E. Thus, the beacon, typically sent at the beginning of every superframe, contains information that may be used to time-synchronize the terminals in the piconet. Each terminal in the piconet, including the PNC, may reset its superframe clock to zero at the beginning of the beacon preamble. If a terminal does not hear a beacon, it may reset its superframe clock to zero at the instant where it expected to hear the beginning of the beacon preamble (e.g., based on previous superframe timing).

### Example Terminal Components

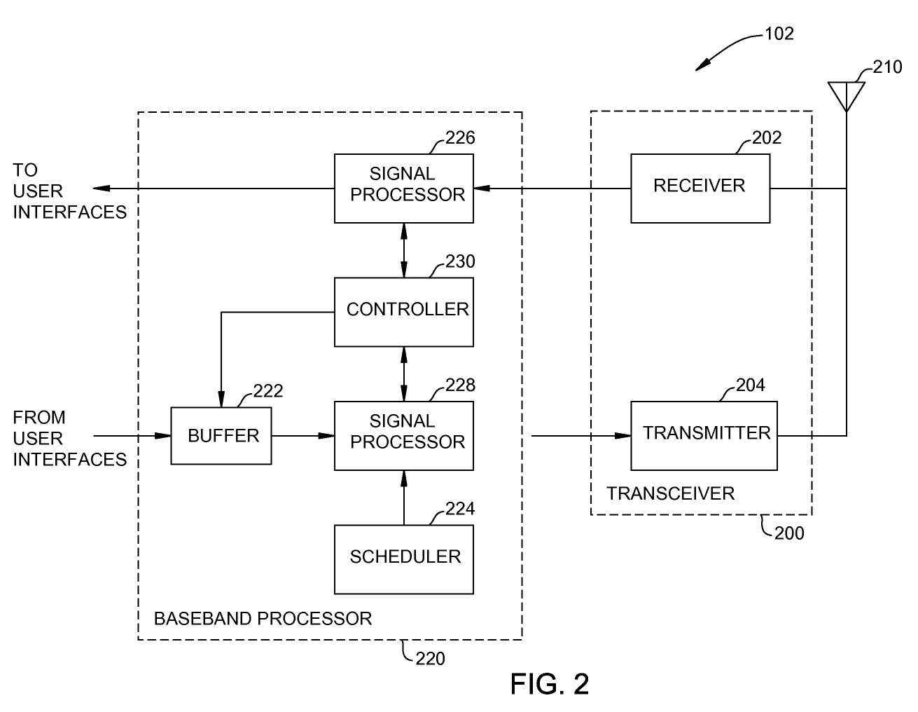

FIG. 2 illustrates example components of a terminal 102 capable of performing operations in accordance with certain aspects of the present disclosure. As those skilled in the art will appreciate, the precise configuration of the terminal 102 may vary depending on the specific application and the overall design constraints and any suitable combination of components capable of performing the operations presented herein may be utilized.

In the example configuration illustrated, the terminal 102 may be implemented with a front-end transceiver 200 coupled to an antenna 210. A baseband processor 220 may be coupled to the transceiver 200. The baseband processor 220 may be implemented with a software based architecture, or another type of architecture. The software based architecture may configured with a microprocessor (not shown) that serves as a platform to run software programs that, among other things, provide executive control and overall system management functions that allow the terminal to operate either as a master or member terminal in a piconet. The baseband processor 220 may also include a digital signal processor (DSP) (not shown) with an embedded communications software layer which runs application specific algorithms to reduce the processing demands on the microprocessor. The DSP may be used to provide various signal processing functions such as pilot signal acquisition, time synchronization, frequency tracking, spread-spectrum processing, modulation and demodulation functions, and forward error correction.

The baseband processor 220 is shown with the transceiver 200. The transceiver 200 may include a receiver 202. The receiver 202 provides detection of desired signals in the presence of noise and interference. The receiver 202 may be used to extract the desired signals and amplify them to a level where information contained in the received signal can be processed by the baseband processor 220.

The transceiver 200 may also include a transmitter 204. The transmitter 204 may be used to modulate information from the baseband processor 220 onto a carrier frequency. The modulated carrier may be upconverted to an RF frequency and amplified to a sufficient power level for radiation into free space through the antenna 210.

The baseband processor 220 may be responsible for configuring the terminal as a master or member terminal of the piconet depending on the results of the pilot signal acquisition process. When the baseband processor 220 configures the terminal as a member terminal of the piconet, a signal processor 228 on the receiving end may be used to extract scheduling information broadcast by the piconet master terminal over one or more control channels. The signal processor 228 may use spread-spectrum processing, in conjunction with digital demodulation and forward error correction techniques, to extract the pertinent scheduling information from the control channel and provide it to a controller 230 for processing. The controller 230 may use the scheduling information to determine the time slots for the various transmissions to and from the member terminal, as well as the power level and data rate for each.

In the receive mode, the controller 230 may be used to provide data rate and spreading information to the signal processor 228 on the receiving end for the scheduled transmissions to the member terminal. Using this information, the signal processor 706 may recover information embedded in the transmissions from other terminals at the appropriate times and provide the recovered information to the various user interfaces.

A signal processor 228 on the transmitting end may be used to spread information destined for various other terminals. The information may be originated from various user interfaces and stored in a buffer 222 until the scheduled transmission. At the scheduled time, the controller 230 may be used to release the information from the buffer 222 to the signal processor 228 for spread-spectrum, processing. The signal processor 228 may also employ digital modulation and forward error correction techniques. The data rate, spreading code and power level of the transmission may be programmed into the signal processor 228 by the controller 230. Alternatively, the transmission power level may be programmed by the controller 230 at the transmitter 204 in the transceiver 200.

When the baseband processor 220 configures the terminal as the master terminal of the piconet, it may enable a scheduler 224. In a software-based implementation of the baseband processor 220, the scheduler 224 may be a software program running on the microprocessor. However, as those skilled in the art will readily appreciate, the scheduler 224 is not limited to this aspect, and may be implemented by other means known in the art, including a hardware configuration, firmware configuration, software configuration, or combination thereof, which is capable of performing the various functions described herein.

The scheduler 224 may be used to generate scheduling information to support intra-piconet communications. The scheduling information may be derived based on any number of considerations and/or in accordance with any known scheduling algorithm. By way of example, scheduling information may be made based on a priority system, where voice communications are given priority over high latency communications. The scheduler 224 may also give priority to high data rate transmissions in an effort to maximize throughput. Further increases in throughput may be achieved by scheduling parallel transmissions using spread-spectrum techniques. By carefully selecting the terminal pairs that will engage in parallel communications, intra-piconet interference may be managed. A fairness criterion that considers the amount of data to be transferred between terminal pairs and the delay already experienced by such terminal pairs may also be considered. Other factors may be considered and are within the scope of the invention. Those skilled in the art will be readily able to adapt existing scheduling algorithms to any particular piconet application.

### Overcoming Limitations of Standard Beacons

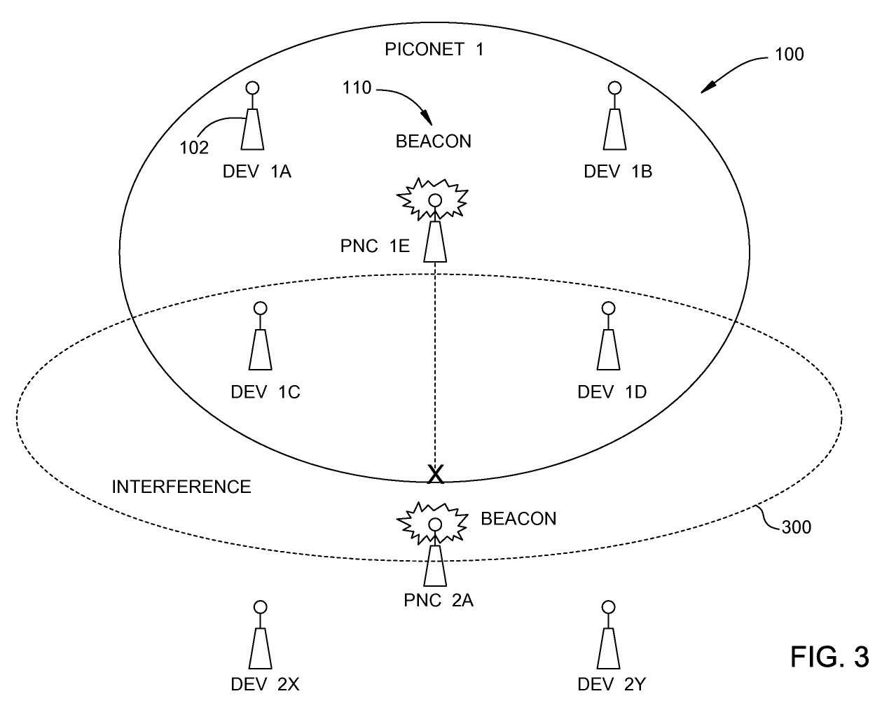

FIG. 3 is a conceptual diagram illustrating an example of a piconet 100 (Piconet 1) having nearby terminals 102 that are not included in the piconet. The illustrated example assumes the nearby terminals PNC 2A, DEV 2X, and DEV 2Y are located in relatively close proximity to Piconet 1, but that PNC 2A is outside the range of transmissions from PNC 1E. The example further assumes that PNC 2A is in transmission range of DEV 1C and DEV 1D.

Since PNC 2A does not receive any beacon signals 110 from PNC 1E (as indicated by the “X” in FIG. 3), PNC 2A is unaware of frequency/time slot assignments within Piconet 1. As a result, PNC 2A may thus attempt to transmit in one or more of the frequency/time slots assigned within Piconet 1. For example, unaware of Piconet 1, PNC 2A may form a second piconet, Piconet 2, with terminals 2X and 2Y. The formation of Piconet 2 may result in an interference zone 300 where transmissions from terminals in the different piconets may interfere. In the illustrated example, terminals 1C and 1D included in Piconet 1 are also within range of Piconet 2 and may, thus, experience interference due to conflicting transmissions from Piconet 2 in the same frequency/time slots.

Certain aspects of the present disclosure, however, may overcome this problem by having all types of terminals included in a piconet (e.g., not just terminals acting as a PNC) transmit beacon signals, referred to herein as unified synchronization packets including synchronization data for the piconet. By having all types of terminals transmit synchronization packets, the range of devices capable of detecting an existing piconet (and the resources allocated to terminals of the existing piconet) may be significantly increased relative to the standard situation with only the PNC transmitting synchronization beacons. In other words, nodes that were previously “hidden” from the PNC of a nearby piconet may learn of the piconet via detection of these sync packets transmitted from non-PNC terminals within range. As a result, the unified synchronization packets may help terminals in proximity of an existing piconet avoid transmitting in the same frequency/time slots allocated to devices in the existing piconet and may, thus, help reduce interference and help support coexistence of adjacent networks.

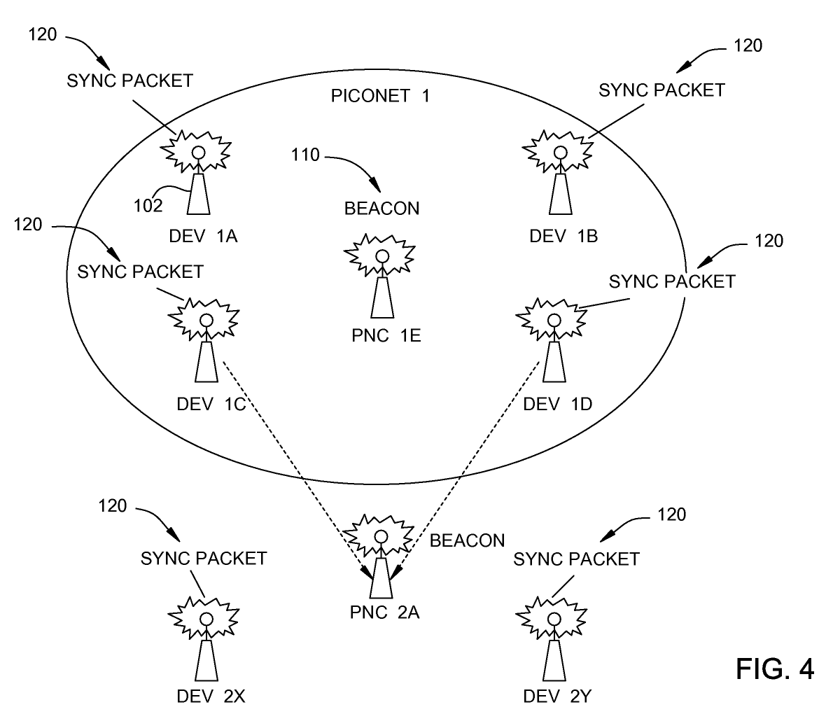

FIG. 4 illustrates synchronization packets 120 being transmitted from all non-PNC terminals in a piconet to reduce transmission interference between a piconet and nearby terminals, in accordance with certain aspects of the present disclosure. As illustrated terminals acting as PNCs (e.g., PNC 1E and PNC 2A) may continue to transmit conventional beacon signals.

As shown, each non-PNC terminal (e.g., DEV 1A, DEV 2X, etc.) transmits a synchronization packet, or “sync packet.” Such sync packets may be transmitted alone or as part of other transmissions (e.g., data frames). Each terminal may transmit a single sync packet, or may transmit multiple sync packets. For example, the terminal may transmit a sync packet upon receiving an allocated/assigned frequency/time slot from a PNC, may transmit a sync packet between every superframe, may transmit in a repeating time cycle, may transmit according to fixed schedule, and the like.

For certain aspects, sync packets may be sent in a manner that allows terminals having a variety of different types of physical layers (PHY) detect them. For example, the IEEE 802.15.3c defines various PHY modes, and devices may be configured to transmit sync packets using a single carrier (SC) that may be detectable by other devices (even if they normally operate in an OFDM mode). Such “unified” sync packets may also help promote the co-existence of networks with different PHY layers. For example, sync packets may be sent from IEEE 802.15 compliant devices in a manner that allows both IEEE 802.15 compliant and IEEE 802.11 compliant devices to detect them. For certain aspects, this may allow devices, such as those compliant with the proposed IEEE 802.11 VHT60 standard with IEEE 802.11 PHY and Medium Access Control (MAC) Layers, to operate in the 60 GHz frequency band (typically 57-66 GHz) with very high throughput, while coexisting with IEEE 802.15.3c systems (and with other systems operating in a similar band).

For certain aspects, each terminal (e.g., PNC-capable and non PNC-capable terminals) may be configured to scan for and detect sync packets and/or beacon signals. For certain aspects, only PNC-capable terminals may be configured to scan for and detect sync packets and/or beacon signals. In any case, by receiving such synchronization information, a terminal can learn of an existing piconet. Further, the receiving terminal may use the synchronization information to avoid interfering with the existing piconet.

For example, referring to FIG. 4, PNC 2A may receive sync packets 120 transmitted by DEV 1C and/or DEV 1D. Because these sync packets may include synchronization information regarding timing and resource allocation for Piconet 1, PNC 2A may avoid transmissions that would cause interference to devices in Piconet 1. For example, PNC 2A may control transmissions to/from DEV 2X and DEV 2Y so they avoid frequency/time slots assigned within Piconet 1, thereby reducing or eliminating any interference with Piconet 1. To accomplish this, the PNC 2A may synchronize its timing with the timing of PNC 1.

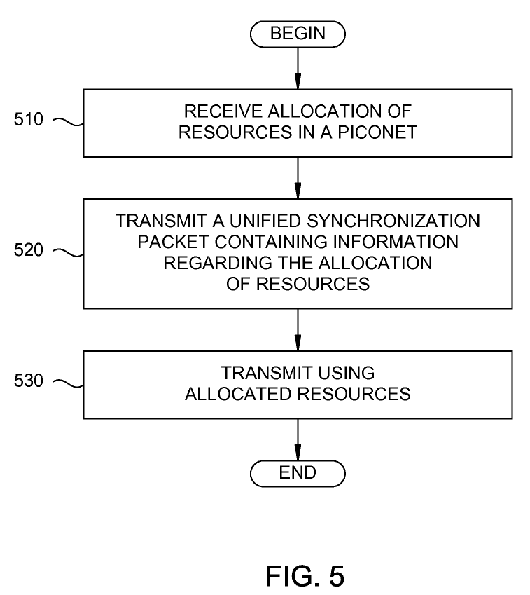

FIG. 5 is a flow diagram illustrating operations 500 for transmitting a unified synchronization packet, in accordance with certain aspects of the present disclosure. FIG. 5 illustrates operations performed, for example, by a non-PNC device included in a piconet.

For the sake of illustration, the operations are described below in conjunction with the example illustrated in FIG. 4. The operations begin at 510, where a non-PNC terminal receives an allocation of transmission resources in a piconet. For example, DEV 1C may receive an allocation of frequency/time slots within Piconet 1 from PNC 1E.

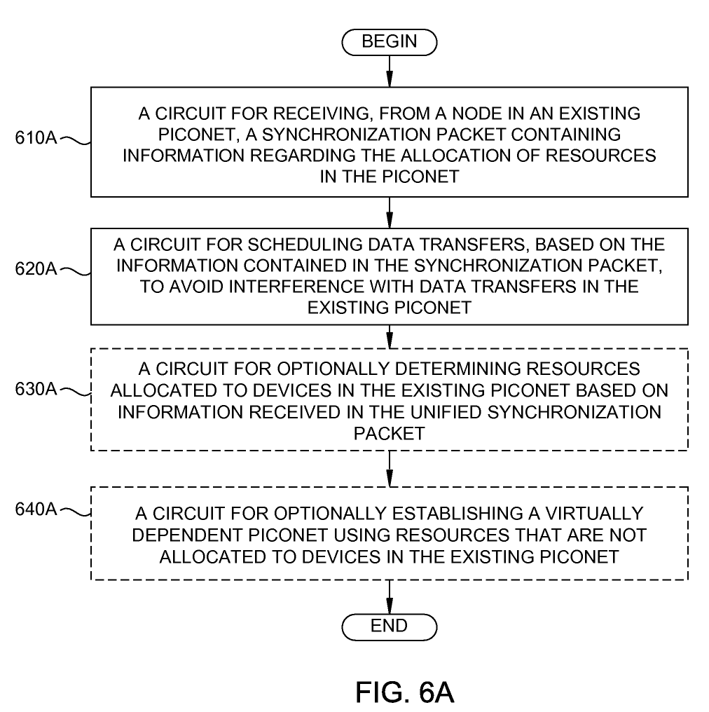

At 520, the terminal may transmit a unified synchronization packet containing information regarding the allocation of resources within the piconet. An example of a unified synchronization packet, its format, and the information contained therein, is described below with reference to FIGS. 8-10.

At 530, the terminal may send transmissions according the resource allocation received at 510. A terminal may send sync packets at any suitable time. For certain aspects, a terminal may transmit when receiving an allocation for transmission. For example, in the case of an 802.15.3c device, each device may send a synchronization packet at least at the first time it receives an allocation to transmit (e.g., including an allocation for ACK packet). As a result, devices that receive these sync packets may become aware of the piconet, even if they are not in range to receive beacons from the piconet PNC.

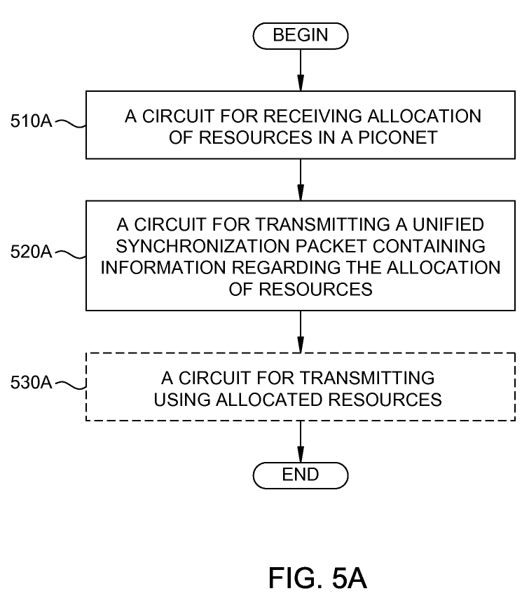

FIG. 6 illustrates example operations for processing a unified synchronization packet, in accordance with certain aspects of the present disclosure. For example, the operations of FIG. 6 may be performed by a PNC device not included in an existing piconet of a terminal that transmitted the synchronization packet.

The operations begin at 610, when a PNC learns of the existence of an existing piconet through the detection of a unified synchronization packet sent from one or more terminal devices of the existing piconet. For example, referring to FIG. 4, PNC 2A may receive a sync packet sent by DEV 1C or DEV 1D, and may thus learn of the existence of Piconet 1.

At 620, the PNC determines a superframe start time and duration corresponding to the existing piconet based on information contained in the unified synchronization packet. The PNC may use such synchronization information to avoid sending transmissions that interfere with Piconet 1. For certain aspects, there may be no fixed timing requirements for exactly when to send a synchronization packet. Therefore, in order to allow a receiving terminal to determine timing information (such as the start of a superframe) of the existing piconet, the sync packet may include a timestamp indicating when the sync packet is sent. The time stamp may be generated by the device sending the sync packet, for example, based on an internal counter reset at the start of a superframe when a beacon signal is received. A device receiving a sync packet may thus be able to determine the start time of a superframe of the existing piconet based on the time stamp.

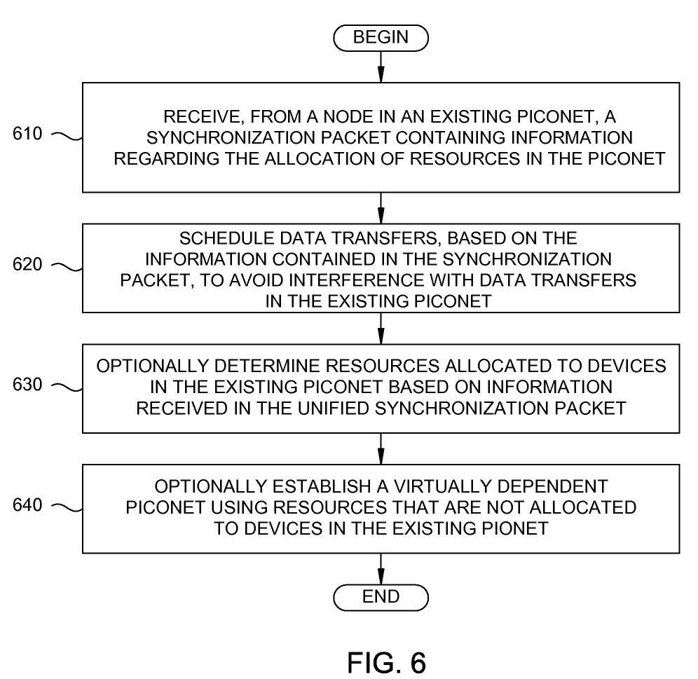

For certain aspects, a PNC receiving a synchronization packet may use the information contained therein about an existing piconet to establish a piconet that is “virtually dependent” on the existing piconet, generally meaning that the piconet may coexists with an existing piconet by avoiding using allocated resources of the existing piconet. The PNC may establish a virtually dependent piconet, such as Piconet 2 illustrated in FIG. 7, for example, by performing optional operations 630 and 640.

At 630, the PNC may determine resources allocated to devices in the existing piconet based on information received in the unified synchronization packet. At 640, the PNC may establish a virtually dependent piconet using resources that are not allocated in the existing piconet. As will be described in greater detail below, the synchronization packet may include Channel Time Allocation (CTA) information elements (IEs) indicating resources allocated to terminals in the existing piconet.

For example, referring to FIG. 7, PNC 2A may determine resource allocation information for Piconet 1 from information in a sync packet 120 sent by DEV 1C or DEV 1D. PNC 2A may then establish Piconet 2 as being virtually dependent on Piconet 1, using available resources that are not already allocated in Piconet 1.

According to certain embodiments, a PNC may perform a periodic scan of the CTA IEs of neighboring piconets (included in the sync packets) to map and mask interference zones as part of virtual dependent piconet maintenance. For example, through these periodic scans, the PNC may learn of changes to resource allocation in the existing piconet and make corresponding adjustments to resource allocations in the virtually dependent piconet.

FIG. 8 illustrates an example format 800 of a sync packet. The format may be similar or the same as a synchronization frame format used for synchronization frames (beacon signals) sent according the IEEE 802.15.3c standard. As shown, the synchronization frame format 800 may include a long preamble, a header, a Header Check Sequence (HCS), a set of parity bits, a synchronization frame body, and a Frame Check Sequence (FCS). The synchronization frame body may include synchronization information regarding an existing piconet, as well as an indication of resources allocated in the existing piconet.

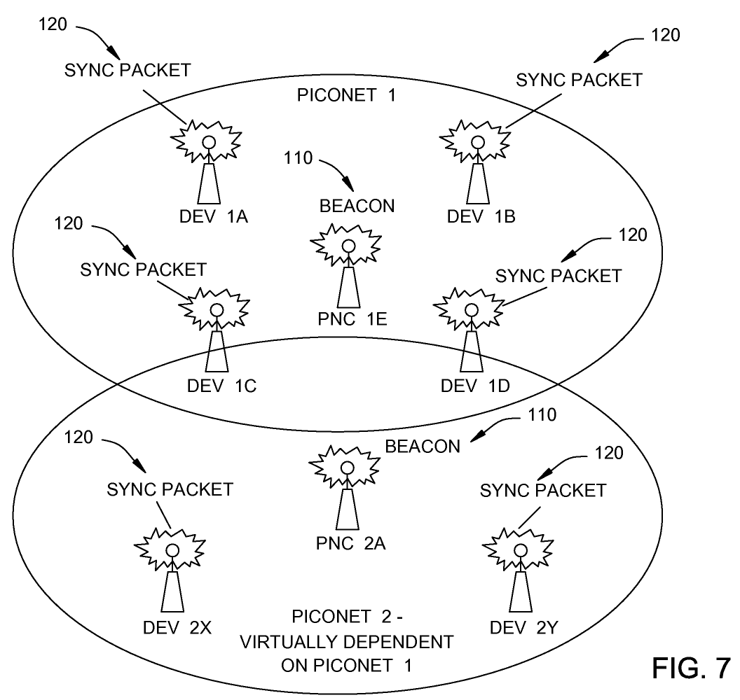

FIG. 9 illustrates an example format of the synchronization frame body of the sync packet. In this example, the synchronization frame body format 900 may be similar to or the same as a synchronization frame format according to the IEEE 802.15.3c standard. As shown, the synchronization frame body format 900 may include synchronization parameters and Channel Time Allocation (CTA) information elements. For example, the CTA information elements may include frequency/time slots assigned to each terminal of a piconet. As described above, a PNC-capable device receiving the CTA IEs may use the information contained therein to identify resources available for allocation to terminals in a virtually dependent piconet.

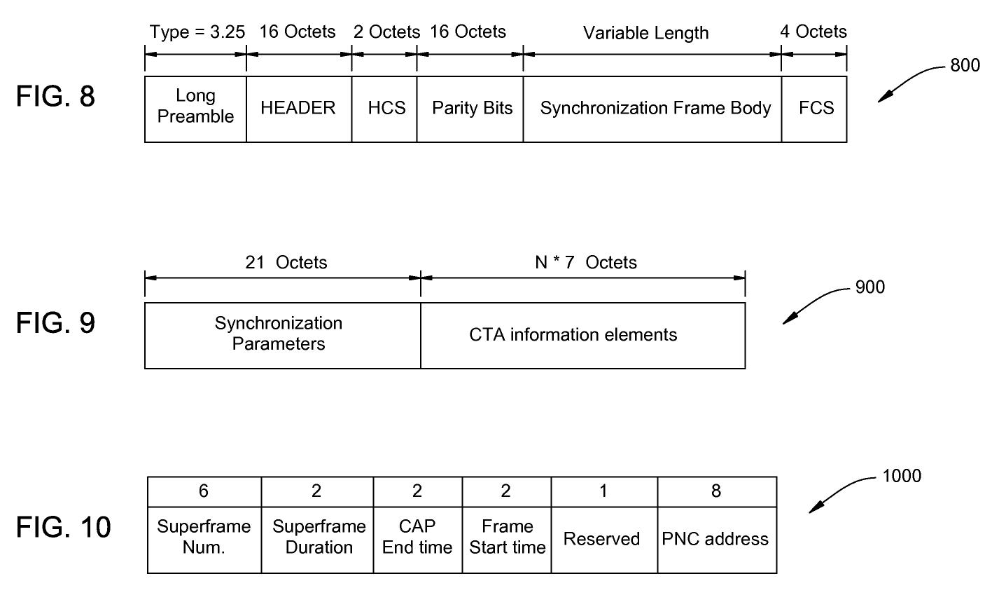

FIG. 10 illustrates example fields 1000 that may be included in the Synchronization Parameters, in accordance with certain aspects of the present disclosure. In this example, the synchronization parameters 1000 may include certain fields that are also used in the IEEE 802.15.3c standard. As illustrated, the synchronization parameters 1000 may include a superframe number, a superframe duration, a contention access period (CAP) end time, a frame start time, a reserved field, and a Piconet Coordinator (PNC) address.

The frame start time may include the time stamp described above, indicating when the sync packet was sent relative to the start of a superframe in the existing piconet. For example, since the common rate (CR) beacon in a piconet is transmitted by the PNC at the start (t=0) of the superframe, and the timing of sending sync packets by non-PNC terminals is not fixed (e.g., each device may only be required to send a synchronization packet at least at the first time its get allocation to transmit), the frame start time may be introduced.

This field provides the time stamp for the synchronization frame and marks the synchronization frame preamble start time. Thus, a PNC receiving the sync packet may use this time stamp to determine the start of a frame preamble and may then schedule data transfers in a manner that helps avoids interference with the existing piconet.

Thus, referring to FIG. 7, even though PNC 2A may not detect beacon signals 110 from PNC 1E, it may use information in the sync packets 120 from DEV 1C and DEV 2C to synchronize data transfers accordingly and form a virtually dependent piconet, Piconet 2. In so doing, PNC 2A may schedule data transfers for members of Piconet 2 (DEV 2X and DEV 2Y) in a manner that avoids interference with data transfers on Piconet 1.

### Example Selection of a Network

A PNC candidate may select which piconet to join in the event that it receives sync packets transmitted from devices in more than one piconet. According to certain aspects, a PNC candidate may select a network based on a PNC address field and choose to join the piconet with the lower value of the PNC address field. This simple algorithm for synchronizing to the piconet with lower value of the PNC address field may apply for network controllers of an exiting piconet. In this scenario, the PNC with the higher address may adopt its timing parameters to synchronize to the piconet with lower value of the PNC address field.

According to certain aspects, in addition to scanning for sync packets during piconet creation, a PNC may also periodically scan for sync frames from neighboring piconets.

A device may synchronize timing with a piconet multiple times in a piconet lifetime. Synchronizing multiple times allows a device to adjust its timing to account for dynamic changes in the piconet environment, for example, such as dynamic changes in interference as devices drift in and out of network coverage area.

### Controlling the Transmission of Sync Packets

According to certain aspects, the particular manner in which a device capable of sending sync packets (or sync frames) actually sends the sync packets may be controlled. For example, according to certain aspects, a PNC may schedule if and when a device sends sync packets and/or with what frequency.

In addition to controlling transmission parameters (such as if, when, and how often to send sync packets), for certain aspects, a PNC may also control various other parameters related to sync packet transmission. For example, to control the direction of sync packet transmission according to certain aspects, a device may have a directional antenna (or antenna array) and the PNC may indicate if sync packets should be sent in certain directions.

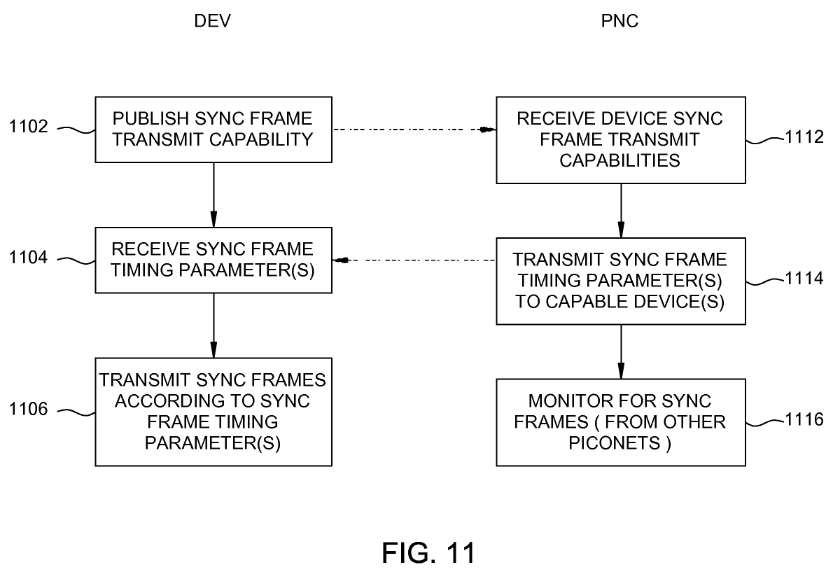

FIG. 11 illustrates example operations that may be performed to schedule the transmission of sync packets by a device in accordance with certain aspects of the present disclosure. FIG. 11 illustrates operations 1102-1106 performed by a non-PNC device, as well as corresponding operations 1112-1116 performed by a device acting as the PNC. Of course, while operations for a single non-PNC device are shown to facilitate understanding, in an actual application there may be several non-PNC devices performing such operations.

As illustrated, at 1102, a device capable of transmitting sync packets may publish that capability and parameters related to sync packet transmission. At 1112, a PNC may receive the device sync frame transmit capabilities published by the device (and possibly one or more other devices).

Publishing the capability to transmit sync packets and parameters related to sync packet transmission may allow a PNC to determine which and how many devices in a piconet are capable of transmitting sync packets. This information may allow the PNC to control if and how sync packets are sent. Exactly how the device publishes the capability may vary with different implementations. For certain aspects, the capability may be published by setting a bit in a capability information element (e.g., a “Sync_frame_capable” bit) included in a frame indicating the device is capable of sending sync packets. In such implementations, a PNC may simply check this bit to see if a corresponding device is capable of transmitting sync frames. For certain aspects, a device may report that it has the capability to send sync frames during an association process.

At 1114, the PNC may transmit one or more sync frame control parameters to capable devices. For certain aspects, the parameters may include an indication of whether or not a device should send sync frames, thereby allowing a PNC to enable/disable sync frame transmissions for a given device or set of devices. The parameters may include an indication of whether or not a device should send sync frames in a particular direction, thereby allowing a PNC to enable/disable sync frame transmissions for a given direction or set of directions. Exactly how the PNC transmits the sync frame control parameters may vary with different implementations.

For certain aspects, the enabling/disabling and/or sync frame parameters (e.g., timing and/or direction) may be transmitted in an information element (IE) of a command frame (e.g., a “Sync_frame_frequency” IE). For certain aspects, sync frame timing may be communicated as an allowable number of superframes between sync frames (effectively specifying a frequency of sync frame transmission). The number of superframes may be specified, for example, as an N-bit field allowing a PNC to specify 1 to 2^{N} (or 0 to 2^{N}−1) superframes between sync frames. For certain aspects, specifying a value of zero in such a bit field may indicate that the transmission of sync frames should be disabled. Such a Sync_frame_frequency IE may be transmitted, for example, in an Announce command if a corresponding device has indicated it is capable of sync frame transmission.

As noted above, according to certain aspects, a device may have a directional antenna and the PNC may indicate when sync packets should be sent in certain directions. When to send sync frames in certain directions may be specified, for example, by sending a number of superframes between sync frame transmissions, with the transmitting device alternating to a different direction in a round-robin format, or according to any other suitable schedule.

At 1104, the device receives the sync frame control parameters. At 1106, the device transmits sync frames in accordance with the sync frame control parameters. For example, assuming the parameters (received at 1104) enabled sync frame transmissions and specified an allowable number of superframes between packets, the device may transmit sync frames with at least that corresponding frequency.

The PNC, meanwhile, may continue to monitor for sync frames from other piconets, at 1116. If the PNC detects a sync frame from other piconets it may respond, as described above. For example, the PNC may control transmissions in its piconet in an attempt to avoid interference and/or establish a virtually dependent piconet.

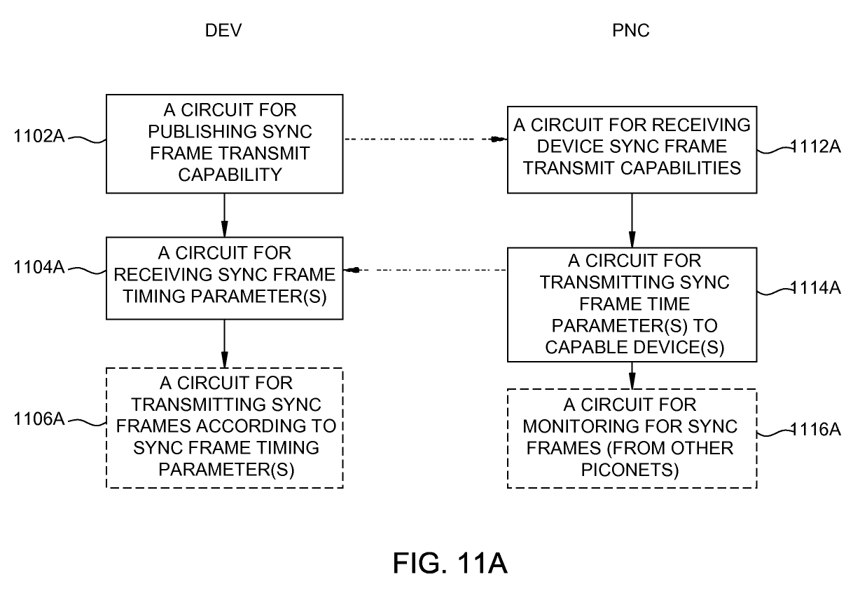

FIG. 12 illustrates an example of a Sync Frame exchange procedure. As illustrated, a first time a CTA for DEV1A to transmit to DEV1C arrives, DEV1A may send a Sync Frame 1220 before sending normal data frames destined to DEV1C. DEV1C, upon receiving the data frame, may waits for a SIFS period and then send a Sync Frame 1220, effectively extending the possible coverage range of the Sync Frame information, before sending an ACK packet destined for DEV1A. After exchange of the Sync frames 1220, normal frame transmission may carry on. As noted above, if requested by PNC1, DEV1A and DEV1C may continue to transmit sync frames, for example, every predetermined number of superframes.

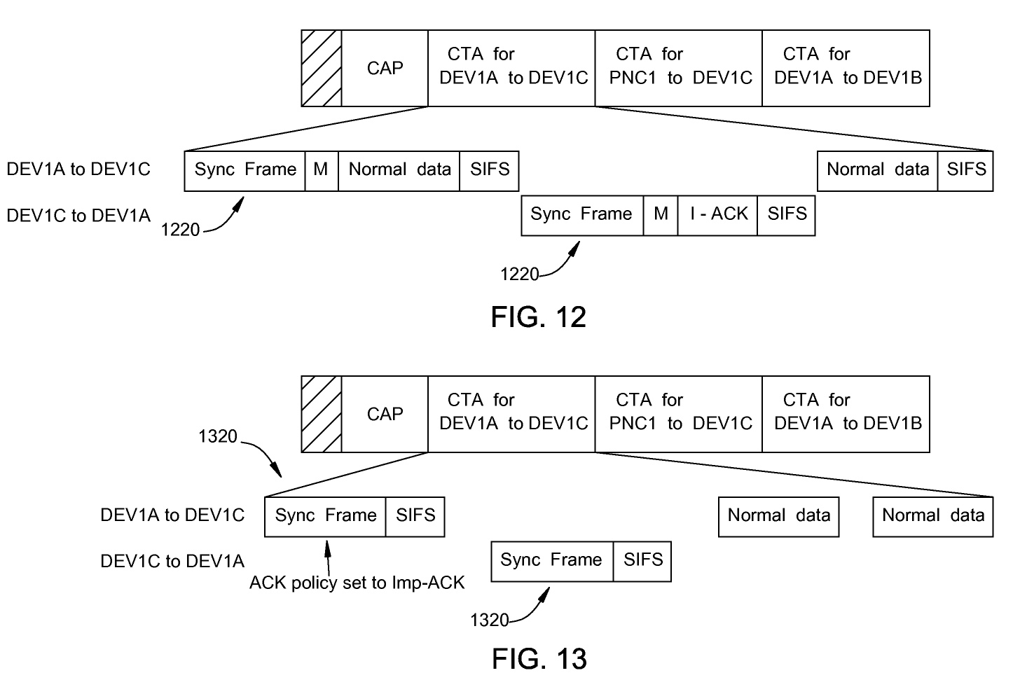

FIG. 13 illustrates another example of a Sync Frame exchange procedure. As illustrated, the first time a CTA for DEV1A to transmit to DEV1C arrives, DEV1A may send a Sync Frame 1320, in this example with the ACK policy set to Implied ACK (IMP-ACK). In this case, DEV1C, upon receiving the Sync Frame 1320, waits for SIFS and replies back with its own Sync Frame 1320, again extending the possible coverage range of the Sync Frame information. After this exchange of Sync frames 1320, normal frame transmission may proceed.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, blocks 510-530, 610-640, and 1102-1116, illustrated in FIGS. 5, 6, and 11 correspond to circuit blocks 510A-530A, 610A-640A, and 1102A-1116A illustrated in FIGS. 5A, 6A, and 11A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure, and recited in the claims below, may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of communication, comprising:
receiving, from a node in a piconet, an allocation of resources for data transmissions in the piconet; and
transmitting a synchronization packet containing information regarding the allocation of resources.

2. The method of claim 1, wherein the synchronization packet information comprises a time stamp indicating a start time of a frame preamble of a frame to be transmitted in the piconet.

3. The method of claim 1, wherein the synchronization packet comprises elements indicating resources allocated to a plurality of terminals in the piconet.

4. The method of claim 1, wherein transmitting a synchronization packet containing information regarding the allocation of resources comprises:
transmitting the synchronization packet in a manner such that the synchronization packet is detectable by devices utilizing different physical layer designs.

5. The method of claim 4, wherein transmitting the synchronization packet in a manner such that the synchronization packet is detectable by devices utilizing different physical layer designs comprises:
transmitting the synchronization packet using a single carrier (SC) detectable by the devices utilizing different physical layer designs.

6. The method of claim 1, wherein the node comprises an access point.

7. The method of claim 1, wherein the node comprises a piconet coordinator (PNC).

8. The method of claim 1, further comprising:
transmitting information indicating the capability to transmit the synchronization packets containing information regarding the allocation of resources in the piconet.

9. The method of claim 8, further comprising:
receiving one or more parameters indicating how the node should transmit synchronization packets.

10. The method of claim 9, wherein the one or more parameters comprise a parameter indicating how frequently the node should transmit synchronization packets.

11. The method of claim 9, wherein the one or more parameters comprise a parameter indicating when to send a synchronization packet in one or more directions using a multidirectional antenna.

12. A method of communication, comprising:
receiving, from a node in an existing piconet that is not acting as a piconet coordinator, a synchronization packet containing information regarding the allocation of resources in the piconet; and
scheduling data transfers, based on the information contained in the synchronization packet, to avoid interference with data transfers in the existing piconet.

13. The method of claim 12, wherein the synchronization packet comprises a time stamp indicating a start time of a frame preamble of a frame to be transmitted in the existing piconet.

14. The method of claim 12, wherein the synchronization packet comprises elements indicating resources allocated to a plurality of nodes in the existing piconet.

15. The method of claim 14, further comprising:
determining available resources that are not allocated to nodes of the existing piconet based on the information elements indicating resources allocated to a plurality of nodes in the existing piconet; and
establishing a virtually dependent piconet by allocating resources of the available resources to nodes in the virtually dependent piconet.

16. The method of claim 15, further comprising:
periodically monitoring information regarding neighboring piconets included in synchronization packets for maintenance of the virtually dependent piconet.

17. The method of claim 12, comprising:
receiving, from one or more nodes in one or more existing piconets, multiple synchronization packets containing information regarding the allocation of resources in the one or more existing piconets; and
scheduling data transfers multiple times, based on the information contained in multiple synchronization packets, to avoid interference with data transfers in the one or more existing piconets.

18. The method of claim 12, wherein the node comprises an access terminal.

19. An apparatus of communication, comprising:
a receiver for receiving, from a node in a piconet, an allocation of resources for data transmissions in the piconet; and
a transmitter for transmitting a synchronization packet containing information regarding the allocation of resources.

20. The apparatus of claim 19, wherein the synchronization packet comprises a time stamp indicating a start time of a frame preamble of a frame to be transmitted in the piconet.

21. The apparatus of claim 19, wherein the synchronization packet comprises elements indicating resources allocated to a plurality of terminals in the piconet.

22. The apparatus of claim 19, wherein the transmitter is configured to:
transmit the synchronization packet in a manner such that the synchronization packet is detectable by devices utilizing different physical layer designs.

23. The apparatus of claim 22, wherein the transmitter is configured to:
transmit the synchronization packet using a single carrier (SC) detectable by the devices utilizing different physical layer designs.

24. The apparatus of claim 19, wherein the node comprises an access point.

25. The apparatus of claim 19, wherein the node comprises a piconet coordinator (PNC).

26. The apparatus of claim 19, further the transmitter is configured to transmit information indicating the capability of transmitting the synchronization packets containing information regarding the allocation of resources in the piconet.

27. The apparatus of claim 26, wherein the receiver is configured to receive one or more parameters indicating how the node should transmit synchronization packets.

28. The apparatus of claim 27, wherein the one or more parameters comprise a parameter indicating how frequently the node should transmit synchronization packets.

29. The apparatus of claim 27, wherein the one or more parameters comprise a parameter indicating when to send a synchronization packet in one or more directions using a multidirectional antenna.

30. An apparatus of communication, comprising:
a receiver for receiving, from a node in an existing piconet that is not acting as a piconet coordinator, a synchronization packet containing information regarding the allocation of resources in the piconet; and
a scheduler for scheduling data transfers, based on the information contained in the synchronization packet, to avoid interference with data transfers in the existing piconet.

31. The apparatus of claim 30, wherein the synchronization packet comprises a time stamp indicating a start time of a frame preamble of a frame to be transmitted in the existing piconet.

32. The apparatus of claim 30, wherein the synchronization packet information comprises elements indicating resources allocated to a plurality of nodes in the existing piconet.

33. The apparatus of claim 32, wherein the scheduler is configured to:
determine available resources that are not allocated to nodes of the existing piconet based on the information elements indicating resources allocated to a plurality of nodes in the existing piconet; and
establish a virtually dependent piconet by allocating resources of the available resources to nodes in the virtually dependent piconet.

34. The apparatus of claim 33, wherein the scheduler is configured to:
periodically monitoring information regarding neighboring piconets included in synchronization packets for maintenance of the virtually dependent piconet.

35. The apparatus of claim 30, wherein the receiver is configured to:
receive, from one or more nodes in one or more existing piconets, multiple synchronization packets containing information regarding the allocation of resources in the one or more existing piconets; and
schedule data transfers multiple times, based on the information contained in multiple synchronization packets, to avoid interference with data transfers in the one or more existing piconets.

36. The apparatus of claim 30, wherein the node comprises an access terminal.

37. An apparatus of communication, comprising:
means for receiving, from a node in a piconet, an allocation of resources for data transmissions in the piconet; and
means for transmitting a synchronization packet containing information regarding the allocation of resources.

38. The apparatus of claim 37, wherein the synchronization packet information comprises a time stamp indicating a start time of a frame preamble of a frame to be transmitted in the piconet.

39. The apparatus of claim 37, wherein the synchronization packet information comprises elements indicating resources allocated to a plurality of terminals in the piconet.

40. The apparatus of claim 37, wherein the means for transmitting a synchronization packet containing information regarding the allocation of resources is configured to:
transmit the synchronization packet in a manner such that the synchronization packet is detectable by devices utilizing different physical layer designs.

41. The apparatus of claim 40, wherein the means for transmitting a synchronization packet containing information regarding the allocation of resources is configured to:
transmit the synchronization packet using a single carrier (SC) detectable by the devices utilizing different physical layer designs.

42. The apparatus of claim 37, wherein the node comprises an access point.

43. The apparatus of claim 37, wherein the node comprises a piconet coordinator (PNC).

44. The apparatus of claim 37, further comprising:
means for transmitting information indicating the capability of transmitting the synchronization packets containing information regarding the allocation of resources in the piconet.

45. The apparatus of claim 44, further comprising:
means for receiving one or more parameters indicating how the node should transmit synchronization packets.

46. The apparatus of claim 45, wherein the one or more parameters comprise a parameter indicating how frequently the node should transmit synchronization packets.

47. The apparatus of claim 45, wherein the one or more parameters comprise a parameter indicating when to send a synchronization packet in one or more directions using a multidirectional antenna.

48. An apparatus of communication, comprising:
means for receiving, from a node in an existing piconet that is not acting as a piconet coordinator, a synchronization packet containing information regarding the allocation of resources in the piconet; and
means for scheduling data transfers, based on the information contained in the synchronization packet, to avoid interference with data transfers in the existing piconet.

49. The apparatus of claim 48, wherein the synchronization packet contains a time stamp indicating a start time of a frame preamble of a frame to be transmitted in the existing piconet.

50. The apparatus of claim 48, wherein the synchronization packet information comprises elements indicating resources allocated to a plurality of nodes in the existing piconet.

51. The apparatus of claim 50, further comprising:
means for determining available resources that are not allocated to nodes of the existing piconet based on the information elements indicating resources allocated to a plurality of nodes in the existing piconet; and
means for establishing a virtually dependent piconet by allocating resources of the available resources to nodes in the virtually dependent piconet.

52. The apparatus of claim 51, wherein the means for establishing a virtually dependent piconet is configured to:
periodically monitoring information regarding neighboring piconets included in synchronization packets for maintenance of the virtually dependent piconet.

53. The apparatus of claim 48, wherein the means for receiving the synchronization packet is configured to:
receive, from one or more nodes in one or more existing piconets, multiple synchronization packets containing information regarding the allocation of resources in the one or more existing piconets; and
schedule data transfers multiple times, based on the information contained in multiple synchronization packets, to avoid interference with data transfers in the one or more existing piconets.

54. The apparatus of claim 48, wherein the node comprises an access terminal.

55. A computer-program product for communication, comprising a computer readable medium encoded with instructions executable to:
receive, from a node in a piconet, an allocation of resources for data transmissions in the piconet; and
transmit a synchronization packet containing information regarding the allocation of resources.

56. A computer-program product for communication, comprising a computer readable medium encoded with instructions executable to:
receive, from a node in an existing piconet that is not acting as a piconet coordinator, a synchronization packet containing information regarding the allocation of resources in the piconet; and
schedule data transfers, based on the information contained in the synchronization packet, to avoid interference with data transfers in the existing piconet.

57. An access point (AP) comprising:
at least one antenna;
a receiver for receiving via the at least one antenna, from a node in a piconet, an allocation of resources for data transmissions in the piconet; and
a transmitter for transmitting, via the at least one antenna, a synchronization packet containing information regarding the allocation of resources.

58. A piconet coordinator (PNC) comprising:
at least one antenna;
a receiver for receiving via the at least one antenna, from a node in an existing piconet that is not acting as a piconet coordinator, a synchronization packet containing information regarding the allocation of resources in the piconet; and
a scheduler for scheduling data transfers, based on the information contained in the synchronization packet, to avoid interference with data transfers in the existing piconet.
